(19) United States
(12) Patent Application Publication
(10) Pub. No.: US 2007/0071854 A1
(43) Pub. Date: Mar. 29, 2007

(54) Edible composition and packaging

(76) Inventors: Kieron Dowd, Dural (AU); Rodney D. Hunwick, Dural (AU)

Correspondence Address: STETINA BRUNDA GARRED & BRUCKER, 75 ENTERPRISE, SUITE 250, ALISO VIEJO, CA, 92656, US

(21) Appl. No.: 11/541,238

(22) Filed: Sep. 29, 2006

Related U.S. Application Data
(63) Continuation of application No. PCT/AU05/00440, filed on Oct. 13, 2005.

(30) Foreign Application Priority Data
Mar. 30, 2004 (AU) AU2004/901693

(51) Int. Cl. A23B 7/148

(52) U.S. Cl. 426/106

(57) ABSTRACT

A packaged edible composition of pet food comprising an inner edible portion and an outer edible portion; said outer edible portion providing at least a partial containing enclosure of said inner portion so as to allow extraction of said edible composition from a package in one contiguous whole.

The present invention relates to edible compositions or combinations and packaging of food items and, more particularly of such food items for pet animals.

### BACKGROUND

The keeping for pleasure, companionship and in some case usefulness of animals is a feature of many societies. The practice of feeding of such animals ranges from reliance of scraps and scavenging by the animal to specially prepared “gourmet” dishes, particularly for domestic pet animals such as cats and dogs.

The industry providing pre-cooked and packaged foods, particularly for cats and dogs is very large and extremely competitive. Manufacturers are continually in search of new marketing opportunities, products and packaging presentation.

Many such food preparations are of a consistency where they are messy and inconvenient to extract from their packaging and often a wasteful residue is left clinging to the inside surfaces of the packaging in such cases. Moreover many do not provided for a balanced diet desirable to maintain the health of an animal.

Animals frequently require vitamin, conditioning and regular various preventative and curative medicinal supplements. These are often difficult to administer and require inconvenient additional acquisition, storage and a discipline regime to maintain correct and regular dosage.

It is an object of the present invention to address or at least ameliorate some of the above disadvantages.

### BRIEF DESCRIPTION OF INVENTION

Accordingly in one broad form of the invention there is provided a packaged edible composition of pet food comprising an inner edible portion and an outer edible portion; said outer edible portion providing at least a partial containing enclosure of said inner portion so as to allow extraction of said edible composition from a package in one contiguous whole.

Preferably said outer edible portion is comprised of a layer of crust-like material of a shape conforming to the inside surface of at least a portion of said package.

Preferably said crust-like material is comprised of a hardened base portion and softer upwardly extending side portions.

Preferably said outer edible portion is adapted to retain said shape for the shelf life of said composition and between removal from said package and consumption.

Preferably said inner edible portion is comprised of any composition of food ingredients suitable for the feeding of domestic pet animals.

Preferably said edible composition includes a separate food ingredient.

Preferably said separate food ingredient is a gravy.

Preferably said separate food ingredient is a sauce.

Preferably said separate food ingredient is enclosed in a sachet.

Preferably said package is comprised of a base portion and a closure portion.

Preferably said base portion is formed of a compactable recycled plastic material or foil.

Preferably said closure portion is comprised of a sheet foil or plastic peel-off lid attached to the rim of said base portion by suitable adhering means.

Preferably said sachet is attached to the underside of said peel-off lid.

Preferably said sachet is provided loose; said sachet lying in a depression under said peel-off lid.

Preferably said package is a cylindrical can.

Preferably said sachet is attached to the inside surface of the upper end of said cylindrical can.

Preferably said sachet is provided loose; said sachet lying in a depression under said upper end of said cylindrical can.

Preferably said inner edible portion is comprised of a biscuit-like material.

Preferably said inner edible portion is provided with a cavity adapted to retain a protein source.

Preferably said biscuit-like material is formed in the likeness of a bone.

Preferably said outer edible portion is substantially comprised of a meat preparation.

Preferably said outer edible portion is of a shape conforming to the inside surface of said package.

Preferably said package is comprised of a plastic sheath shaped so as to resemble a sausage.

Preferably said plastic sheath is provided with a zipper portion extending substantially the length of said sheath; said zipper portion adapted to allow ejection of said edible composition from said sheath as a contiguous whole.

Preferably said package is a cylindrical can.

Preferably said packaged edible composition includes a separate supplement.

Preferably said supplement is a vitamin supplement.

Preferably said supplement is a condition enhancing supplement.

Preferably said supplement is a curative medicinal supplement.

Preferably said supplement is a preventative medicinal supplement.

Preferably said supplement is retained in a cavity formed in an edible portion of said edible composition.

Preferably said supplement is retained in a sachet.

Preferably said sachet is attached to the inside of a cover portion of said package.

Accordingly in a further broad form of the invention there is provided a method of presenting a food composition to domestic pet animals; said method including the steps of:
(a) preparing said food composition as an inner edible portion and an outer edible portion,
(b) including said food composition in a package comprising a base portion and a peel-off lid portion,
(c) removing said food composition from said package,
(d) placing said food composition for consumption by said animals.

Preferably said outer edible portion is in the form of a layer of crust-like material shaped so as to conform to the inside of said package.

Preferably said inner edible portion is comprised of any composition of food ingredients suitable for the feeding of said domestic pet animals.

Accordingly in a further broad form of the invention there is provided a method of presenting a packaged food composition and a mixable separate food ingredient to a domestic pet animal; said method including the steps of:
(a) preparing said food composition for enclosure in a package comprising a base portion and a peel-off lid portion,
(b) enclosing said mixable separate food ingredient in a sachet,
(c) attaching said sachet to the underside of said peel-off lid portion,
(d) removing said food composition from said package,
(e) removing said mixable food ingredient from said sachet for distribution over said food composition.

Accordingly in a further broad form of the invention there is provided an animal nutritional composition comprising three juxtaposed nutrient structures; a first nutrient structure comprising a liquid carrier containing a protein source; a second nutrient structure comprising a substantially solid carrier containing a fibre source; a third nutritional structure comprising a bulk gel carrier containing a carbohydrate source.

Preferably said protein source is at least partially provided in a separate gravy food ingredient.

Preferably said protein source is at least partially provided in a separate sauce food ingredient.

Preferably said fibre source is substantially provided in a biscuit-like portion of said composition.

Preferably said carbohydrate source is substantially provided in said biscuit like portion of said composition.

Preferably said substantially solid carrier forms at least a partial enclosure for said bulk gel carrier; said partial enclosure including a base portion and side portions.

Preferably said substantially solid carrier forms a complete enclosure of said bulk gel carrier.

Preferably said composition is enclosed in packaging.

Preferably said liquid carrier is enclosed in a sachet included within said packaging.

Preferably said packaging is comprised of a base portion and a closure portion.

Preferably said base portion and said closure portion are formed of plastic or foil.

Preferably said packaging is comprised of a metal cylindrical can.

Preferably said liquid carrier is enclosed in a cavity provided in said substantially solid carrier.

Preferably said substantially solid carrier is enveloped in said bulk gel carrier.

Preferably said composition is enclosed in packaging.

Preferably said packaging is comprised of a plastic sheath.

Preferably said packaging is comprised of a metal cylindrical can.

In yet a further broad form of the invention there is provided an animal nutritional composition comprising two juxtaposed nutrient structures; a first nutrient structure comprising a liquid carrier containing a protein source and a second nutrient structure comprising a substantially solid carrier containing a fibre source.

Preferably said composition includes a further nutrient structure comprising a bulk gel carrier containing a carbohydrate source.

In yet a further broad form of the invention there is provided an animal nutritional composition comprising two juxtaposed nutrient structures; a first nutrient structure comprising a substantially solid carrier containing a fibre source and a second nutritional structure comprising a bulk gel carrier containing a carbohydrate source.

Preferably said composition includes a further nutrient structure comprising a liquid carrier containing a protein source.

In yet a further broad form of the invention there is provided an animal nutritional composition comprising two juxtaposed nutrient structures; a first nutrient structure comprising a liquid carrier containing a protein source and a second nutritional structure comprising a bulk gel carrier containing a carbohydrate source.

### BRIEF DESCRIPTION OF DRAWINGS

Embodiments of the present invention will now be described with reference to the accompanying drawings wherein:

FIG. 1 is a cross section elevation through a preferred embodiment of an edible composition and packaging according to the invention.

FIG. 2 is a perspective view of the edible composition and packaging of FIG. 1 with the peel-off cover portion removed.

FIG. 3 is a side elevation view of the edible composition and packaging of FIGS. 1 and 2 with the peel-off cover portion partially removed from the packaging revealing a sachet of separate food ingredient attached to the underside of the cover.

FIG. 4 is a sectioned view of a further embodiment of an edible composition and packaging according to the invention.

FIG. 5 and 6 are sectioned views of further embodiments of an edible composition and packaging according to the invention.

FIG. 7 is a sectioned view of yet a further embodiment of an edible composition and packaging according to the invention.

### DETAILED DESCRIPTION OF PREFERRED EMBODIMENTS

The present invention seeks to provide combinations of three main elements desirable in a pet food, that is, taste, texture and nutrition, in a variety of compositions and packaging. The three elements according to the present invention may be incorporated in any one or in all of a number of disparate edible components within any of the preferred embodiments of packaging described in detail below.

### First Preferred Embodiment

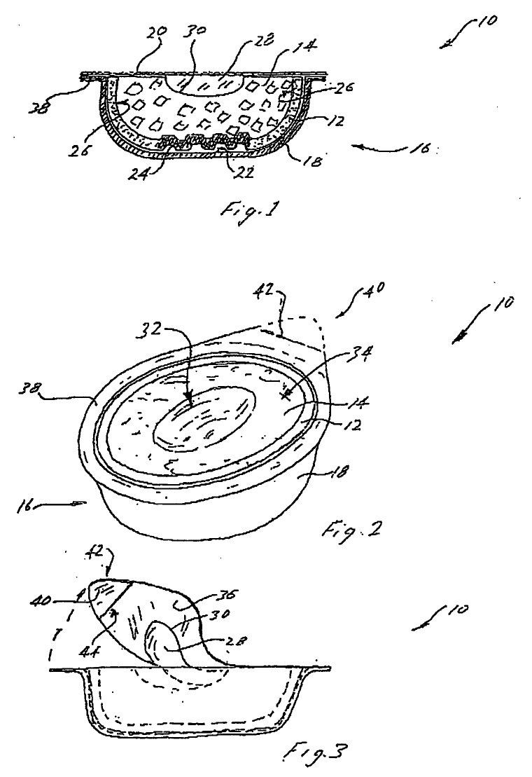

With reference to FIG. 1 a packaged edible composition of pet food 10 is comprised of an outer edible portion 12 and an inner edible portion 14 enclosed in a package 16 comprised of base portion 18 and peel-off cover portion 20.

The edible outer portion 12 is, in at least one preferred embodiment of the invention, composed of a layer of crust-like material so as to form a container adapted to at least partly enclose and retain the edible inner portion 14 such that the inner edible portion 14 is not in contact with the inner surface 22 of base portion 18 of package 16. The layer of crust-like material may be a biscuit composition for example and is shaped to conform to the inner surface 22 of the base portion 18 of package 16. In at least one further preferred embodiment the edible outer portion 12 may be in the form of a pastry type crust.

Preferably, though not necessarily, the base portion 24 of outer edible portion 12 may be of a thicker or harder composition then the upwardly extending edge portions 26. In at least one preferred embodiment outer edible portion 12 or at least the base portion thereof is of a composition adapted to provide fiber into the diet of the animal.

Regardless of the composition of outer edible portion 12, it is adapted to retain its original shape as packaged as well as its properties of retention of the inner edible portion for the shelf life of the product. As well its properties are such as to not stick to the inner surface 22 of the package so that both inner and outer edible portions are readily removable from the package when required for use and the shape of the edible composition retained until addressed by a consuming animal.

The inner edible portion 14 may be comprised of any suitable pet food such as for example chunks of meat held in a matrix of a gel and is formulated for properties of taste, texture and nutrition. Alternatively, the inner edible portion may consist of dry palletized food ingredients.

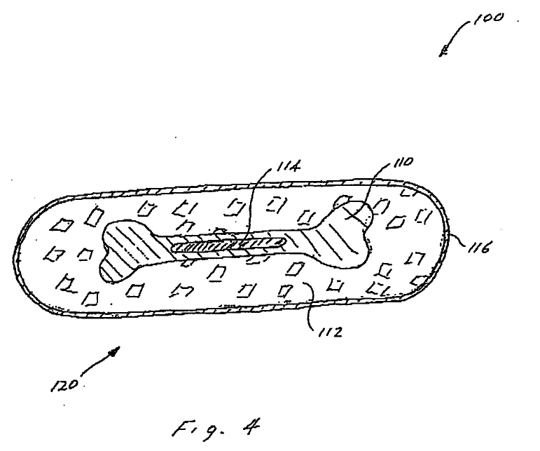

Also with reference to FIG. 1 in a further preferred embodiment of the invention, packaged edible composition 10 includes a mixable separate food ingredient 28. Food ingredient 28 is contained in a sachet 30 and, as may best be seen in FIG. 2, is so arranged as to fill a depression 32 generally in the middle of the upper surface 34 of inner edible portion 14. In at least one preferred form of this embodiment as shown in FIG. 3, sachet 30 is attached to the underside 36 of peel-off cover portion 20 of package 16.

Separate food ingredient 28 may be a gravy for example or a sauce adapted to add flavour, moisture and nutrition to both the inner edible and outer edible portions of the edible composition. Separate food ingredient 28 may further be formulated as an additional protein source.

The base portion 18 of package 16 is preferably formed of compactable and recycled plastic or foil. The peel-off cover portion 20 may be of a suitable foil or plastic sheet material and attached to the rim 38 of base portion 18 by any suitable means such as for example heat or ultrasonic welding. For convenience, package 16 may be provided with an outwardly extending tab portion 40 on base portion 18 (shown in broken outline in FIG. 2) and a corresponding tab portion 42 on peel-off cover portion 20 as best seen in FIG. 3. The base portion tab 40 may be provided with perforations 42 adapted to allow tab 40 to snap off when sufficient force is applied and, by remaining attached to the peel-off cover tab portion 42, provide a convenient grasping element allowing the peeling off of the cover 20.

Package 16 may be of any convenient shape such as circular as shown in FIGS. 1 to 3 for example, or it may be of oval, square, rectangular, diamond shaped or cylindrical.

In use, the peel-off cover portion 20 is removed from the base portion 18. This also pulls the sachet 30 if provided, from the depression 32 in inner edible portion 14. Edible outer portion 12 and edible inner portion 14 are then readily slid out of base portion 18 of package 16 as a contiguous whole and cleanly deposited for example in the feed bowl of an intended animal consumer. The sachet 30, if provided, may then be pierced and its contents spread over the inner and outer edible portions.

### Second Preferred Embodiment

In a further preferred embodiment, the outer edible portion could be provided as a complete enclosure of the inner edible portion, this being then comprised of a base portion and sides with a lid portion of the same edible composition.

A particular advantage of the above described composition is its improved shelf life.

### Third Preferred Embodiment

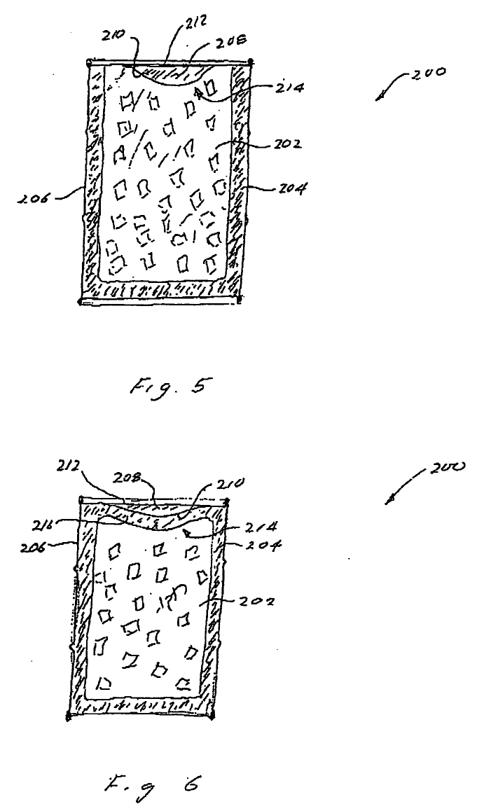

In yet a further preferred embodiment of the invention there is provided as shown in FIG. 4 an edible composition 100 comprised of an inner edible portion 110 in the form of a biscuit-like preparation and an outer edible portion 112 substantially in the form of a meat preparation.

Inner edible portion 110 may for example be shaped as a bone and in at least one preferred form of this embodiment, may include a central cavity 114 filled with an edible gel. The edible gel may range in consistency from a viscous slurry to a near solid.

Inner edible portion 110 is further preferably formulated so as to provide a source of carbohydrate and fiber to the animal and as well provide a chewable element conducive to its dental health.

Edible composition 100 in this embodiment is enclosed in packaging comprising a sheath or skin 116 of plastic, preferably to provide a sausage shaped package 120 provided with a tear open zipper (not shown) . In use the zipper which extends substantially the length of the package is adapted to allow the whole of edible composition 100 to be ejected from the package for placement for example in the feed bowl of an intended animal consumer.

Edible composition may further be formulated for frozen or refrigerated storage prior to sale and prior to use.

### Fourth Preferred Embodiment

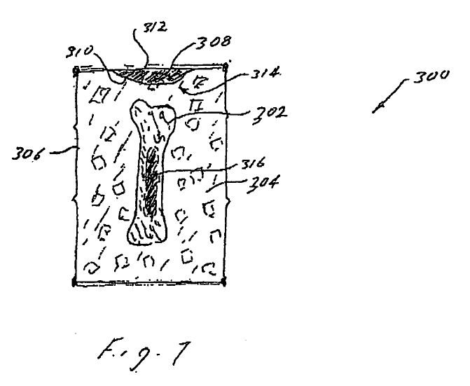

In yet a further preferred embodiment of the invention with reference to FIGS. 5 and 6 a packaged edible composition of pet food 200 is comprised of an inner edible portion 202 and an outer edible portion 204 enclosed in a cylindrical sealed can 206. Outer edible portion 204 in at least one preferred form of this embodiment is composed of a biscuit-like layer conforming to the inside surfaces of at least the sides and base of the can 206, but may also completely envelop inner edible portion 202 as shown in FIG. 6. The inner edible portion may then be comprised of any suitable pet food such as for example chunks of meat in a matrix of a gel. In this embodiment also, the inner edible portion could be in the form of dry palletized food ingredients.

In this preferred embodiment also, a mixable separate food ingredient 208 may be supplied in a separate sachet 210 retained between a circular upper end 212 of the can 206 and a depression 214, either in the upper surface of inner edible portion 214 or in a suitable depression in upper portion 216 of outer edible portion 204 where outer edible portion 204 completely encloses the inner edible portion 202.

In at least one preferred form of this embodiment mixable separate food ingredient may be supplied in a sachet releasable attached to the inside of the circular upper end 212 so that when the lid is removed from the can the sachet is pulled from its retaining depression 214.

### Fifth Preferred Embodiment

With reference to FIG. 7 packaged edible food composition 300 is provided in a cylindrical can 306 and comprises an outer edible portion 304 and an inner edible portion 302. In this embodiment it is the inner edible portion 302 which is composed of a biscuit-like material and may be formed for example in the shape of a bone. The outer edible portion 304 may then be comprised of any suitable pet food such as for example chunks of meat held in a matrix of a gel, but could also be comprised of dry pelletized food ingredients.

In at least one preferred form of this embodiment a mixable separate food ingredient 308 may be provided in a sachet 310 retained between the circular upper end 312 of can 306 and a depression 314 in the upper surface of outer edible food portion 304. In this form also the sachet 310 may be attached to the inside of circular upper end 312.

In at least one other preferred form of this embodiment the inner edible portion 302 may be provided with an internal cavity 316 adapted to contain a preferred food supplement such as for example a protein rich composition.

Nutritional Structure

The composition of the various elements of the food ingredients of the above described embodiments rely on a balanced juxtaposition of nutritional structures. Broadly, these may be considered as consisting of three main sources comprising a carrier containing a protein source, a carrier containing a fibre source and a carrier containing a carbohydrate source.

The fibre and carbohydrate sources may primarily be provided in the biscuit-like portions of the packaged edible food compositions of the above described embodiments. The other edible portion may also provide both fibre and/or carbohydrate depending on the chosen composition of the suitable pet food. Likewise this portion will carry at least some of the protein.

Composition of Supplement

Additional protein may be provided in the separate food ingredient of the sachet gravy or sauce for example.

Alternatively, the sachet may be used in any one of the above embodiments as a carrier for additional vitamin supplements, or a conditioning, curative or preventative medicinal compound.

The above describes only some embodiments of the present invention and modifications, obvious to those skilled in the art, can be made thereto without departing from the scope and spirit of the present invention.

1. A packaged edible composition of pet food comprising an inner edible portion and an outer edible portion; said outer edible portion providing at least a partial containing enclosure of said inner portion so as to allow extraction of said edible composition from a package in one contiguous whole.

2. The packaged edible composition of claim 1 wherein said outer edible portion is comprised of a layer of crust-like material of a shape conforming to the inside surface of at least a portion of said package.

3. The packaged edible composition of claim 2 wherein said crust-like material is comprised of a hardened base portion and softer upwardly extending side portions.

4. The packaged edible composition of claim 1 wherein said outer edible portion is adapted to retain said shape for the shelf life of said composition and between removal from said package and consumption.

5. The packaged edible composition of claim 1 wherein said inner edible portion is comprised of any composition of food ingredients suitable for the feeding of domestic pet animals.

6. The packaged edible composition of claim 1 wherein said edible composition includes a separate food ingredient.

7. The packaged edible composition of claim 6 wherein said separate food ingredient is a gravy.

8. The packaged edible composition of claim 6 wherein said separate food ingredient is a sauce.

9. The packaged edible composition of claim 6 wherein said separate food ingredient is enclosed in a sachet.

10. The packaged edible composition of claim 1 wherein said package is comprised of a base portion and a closure portion.

11. The packaged edible composition of claim 10 wherein said base portion is formed of a compactable recycled plastic material or foil.

12. The packaged edible composition of claim 10 wherein said closure portion is comprised of a sheet foil or plastic peel-off lid attached to the rim of said base portion by suitable adhering means.

13. The packaged edible composition of claim 12 wherein said sachet is attached to the underside of said peel-off lid.

14. The packaged edible composition of claim 12 wherein said sachet is provided loose; said sachet lying in a depression under said peel-off lid.

15. The packaged edible composition of claim 1 wherein said package is a cylindrical can.

16. The packaged edible composition of claim 15 wherein said sachet is attached to the inside surface of the upper end of said cylindrical can.

17. The packaged edible composition of claim 15 wherein said sachet is provided loose; said sachet lying in a depression under said upper end of said cylindrical can.

18. The packaged edible composition of claim 1 wherein said inner edible portion is comprised of a biscuit-like material.

19. The packaged edible composition of claim 18 wherein said inner edible portion is provided with a cavity adapted to retain a protein source.

20. The packaged edible composition of claim 18 wherein said biscuit-like material is formed in the likeness of a bone.

21-61. (canceled)
